(19) United States
(12) Patent Application Publication
(10) Pub. No.: US 2024/0083070 A1
(43) Pub. Date: Mar. 14, 2024

(54) A ROTOR, A PLASTICS PROCESSING APPARATUS AND AN ASSOCIATED MEHTOD

(71) Applicant: PlasTech Recycling Limited, Charlestown, New South Wales (AU)

(72) Inventors: Colin Barker, Charlestown, New South Wales (AU); Peter Barker, Charlestown, New South Wales (AU); Ronald Slocombe, Charlestown, New South Wales (AU)

(21) Appl. No.: 18/269,936

(22) PCT Filed: Jan. 14, 2022
(86) PCT No.: PCT/AU2022/050015

§ 371 Date: Jun. 27, 2023

(30) Foreign Application Priority Data
Jan. 29, 2021 (AU) 2021900192

(51) Int. Cl. B29B 13/02; B29B 7/82

(52) U.S. Cl. CPC B29B 13/022; B29B 7/826

(57) ABSTRACT

The apparatus (1) includes a frictional heater (2), within which a rotor (3) is utilised, which includes a substantially cylindrical member (4) disposed about a central axis (5). The rotor (3) is rotatably mounted within the frictional heater (2) such that the axis of rotation is co-extensive with the central axis (5). The substantially cylindrical member (4) defines an outer periphery (6) configured, in use, to bear against plastic whilst rotating. To help address various issues that may otherwise arise during operation of the apparatus (1), the outer periphery has a diameter of between approximately 0.2 m and approximately 2.0 m inclusive.

### TECHNICAL FIELD

The present invention relates to devices and associated methods for processing plastics materials. Embodiments of the present invention find application, though not exclusively, in the field of plastics recycling.

### BACKGROUND ART

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

Embodiments of the present invention relate to improvements to systems, methods and apparatus of the types disclosed in PCT Publication No. WO 2014/186836 as invented by Mr Ross Collins. This patent family has proceeded to grant in various jurisdictions, including Australia (Australian Patent No. 2014271200), Europe (European Patent No. 3003668) and the United States of America (U.S. Pat. No. 10,052,795), to name but a few. The contents of each of these aforementioned published patent specifications are hereby incorporated in their entirety by way of reference.

It has been appreciated by the inventors of the present application that aspects of the systems, methods and apparatus disclosed in the publications mentioned in the preceding paragraph may benefit from various refinements to further improve the plastics processing potential, the efficiency and/or to address practical operational issues.

### SUMMARY OF THE INVENTION

It is an object of the present invention to overcome, or substantially ameliorate, one or more of the disadvantages of the prior art, or to provide a useful alternative.

According to a first aspect of the invention there is provided a rotor for use within a frictional heater, the rotor including: a substantially cylindrical member disposed about a central axis, the substantially cylindrical member defining an outer periphery configured, in use, to bear against plastic, the substantially cylindrical member further defining a hollow interior; a plurality of molten plastic conduits extending between said outer periphery and said hollow interior; and the hollow interior being in fluid communication with an outlet; wherein the outer periphery has a diameter of between approximately 0.2 m and approximately 2.0 m inclusive. Preferably the outer periphery has a diameter of between approximately 0.3 m and approximately 1.5 m inclusive.

Preferably the cylindrical member defines an inner face substantially enclosing the hollow interior, the inner face being concentric with the outer periphery and wherein a thickness between the outer periphery and the inner face is between approximately 3 mm and approximately 20 mm inclusive.

In an embodiment each of the molten plastic conduits has a cross-sectional area of between approximately 12 mm² and approximately 180 mm² inclusive. In another embodiment each of the molten plastic conduits has a circular cross-sectional shape having a diameter of between approximately 4 mm and approximately 15 mm inclusive.

In an embodiment a heating element is disposed adjacent the outlet. Preferably a hollow tapered section is disposed intermediate the cylindrical member and the outlet. Preferably the heating element is disposed on or adjacent to an external surface of the hollow tapered section.

In one embodiment a total surface area of the molten plastic conduits comprises between approximately 1% and approximately 30% of a total surface area of the outer periphery that is configured, in use, to bear against plastic. Preferably between approximately 1,000 and approximately 15,000 molten plastic conduits per meter are disposed on the outer periphery that is configured, in use, to bear against plastic.

According to a second aspect of the invention there is provided a plastics processing apparatus including: a frictional heater having a rotor as defined in any of the preceding claims rotatably disposed therein such that an axis of rotation of the rotor is co-extensive with said central axis; at least one pusher configured, in use, for the pushing of plastic into frictional engagement with said outer periphery; and a drive operably coupled to the rotor.

In one embodiment the drive is configured so as, in use, to rotate the rotor such that the outer periphery has a velocity of between approximately 0.5 m/s and approximately 5.0 m/s inclusive. Preferably, the drive is configured so as, in use, to rotate the rotor such that the outer periphery has a velocity of between approximately 1.0 m/s and approximately 3.0 m/s inclusive. In another embodiment the drive is configured so as, in use, to rotate the rotor at a rate of between approximately 20 rpm and approximately 200 rpm inclusive.

Preferably the pusher is configured, in use, to push plastic into frictional engagement with said outer periphery at a pressure of between approximately 100 KPa and approximately 1000 KPa inclusive.

According to a third aspect of the invention there is provided a method for processing plastic including: providing a plastics processing apparatus as described above; using the pusher to push plastic feedstock into frictional engagement with the outer periphery of the rotor so as to substantially melt the plastic feedstock; and allowing substantially molten plastic to flow through the plurality of molten plastic conduits to the hollow interior of the rotor so as to perform intimate mixing of the molten plastic.

In an embodiment of the method the rotor is rotated such that the outer periphery has a velocity of between approximately 0.5 m/s and approximately 5.0 m/s inclusive. Preferably the rotor is rotated such that the outer periphery has a velocity of between approximately 1.0 m/s and approximately 3.0 m/s inclusive. In another embodiment of the method the rotor is rotated at a rate of between approximately 20 rpm and approximately 200 rpm inclusive.

Preferably the plastic is pushed towards the outer periphery of the rotor such that the plastic frictionally engages with said outer periphery at a pressure of between approximately 100 KPa and approximately 1000 KPa inclusive.

According to a fourth aspect of the invention there is provided plastic processed by a plastics processing apparatus as described above.

According to a fifth aspect of the invention there is provided plastic processed by a method as described above.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is an exploded isometric view of an embodiment of the invention;

FIG. 2 is a detail isometric view of the shoe retaining pin marked A in FIG. 1;

FIG. 3 is a detail isometric view of the loading door cylinder marked B in FIG. 1;

FIG. 4 is a detail isometric view of the loading door hinge marked C in FIG. 1;

FIG. 5 is a detail isometric view of the wire encoder marked D in FIG. 1;

FIG. 6 is a detail isometric view of a region of the apparatus marked E in FIG. 1 onto which an access panel may be installed;

FIG. 7 is a sectional side view showing an upper portion of the drive/rotor/pusher region of the preferred embodiment;

FIG. 8 is a detail sectional side view of the region marked F in FIG. 7;

FIG. 9 is a detail sectional side view of the region marked Gin FIG. 7;

FIG. 10 is a detail sectional side view of the region marked H in FIG. 7;

FIG. 11 is a sectional side view showing a lower portion of the rotor/pusher/outlet region of the preferred embodiment; and

FIG. 12 is a detail sectional side view of the region marked I in FIG. 11.

### DETAILED DESCRIPTION OF PREFERRED EMBODIMENTS OF THE INVENTION

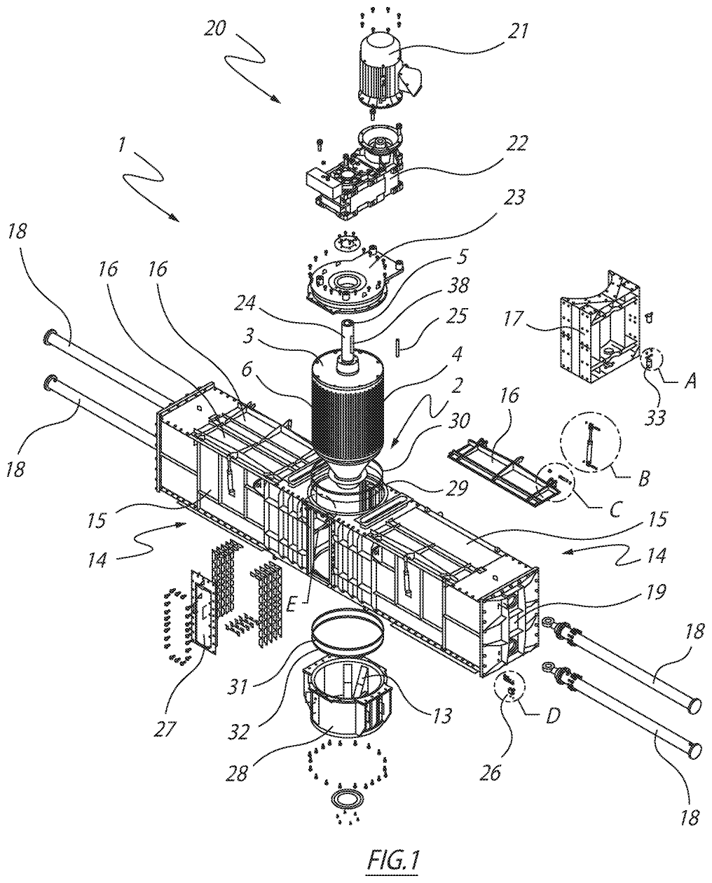

FIG. 1 illustrates a plastics processing apparatus 1 that utilises the general principles disclosed in PCT Publication No. WO 2014/186836. This apparatus 1 is designed to receive various types of soft waste plastics, potentially including contaminants, and to melt those plastics to provide a molten plastic substrate that can be formed into useful products, for example by extrusion, moulding or the like.

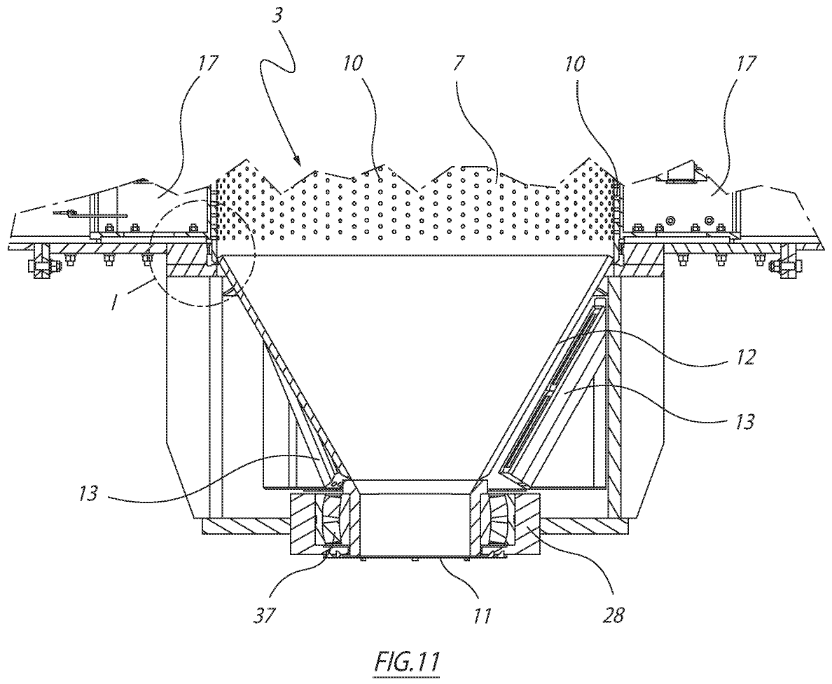

The apparatus 1 includes a frictional heater 2, within which a rotor 3 is utilised. The rotor 3 is best illustrated in FIGS. 1, 7 and 11 and it includes a substantially cylindrical member 4 disposed about a central axis 5. The rotor 3 may be formed from any material having suitable strength, friction and wear properties, such as, for example, metallic materials including mild steel, stainless steel, and alloys, ceramics or materials having coatings providing desirable strength, friction and/or wear properties. The stainless steel option is particularly suited for the processing of plastics such as PVC and other plastics containing chlorine and/or acid.

In general, the rotor 3 is rotationally symmetrical about central axis 5 and, in use, the rotor 3 is rotatably mounted within the frictional heater 2 such that the axis of rotation is co-extensive with the central axis 5. The substantially cylindrical member 4 defines an outer periphery 6 configured, in use, to bear against plastic whilst rotating and thereby frictionally heat the plastic. In use, the frictional heating causes a layer of molten plastic to surround the outer periphery 6 and this helps promote mixing and homogenising of the molten plastic.

The cylindrical member 4 also defines an inner face 7 substantially enclosing a hollow interior 8 of the rotor 3. The inner face 7 is concentric with the outer periphery 6. A plurality of molten plastic conduits 10 extend between the outer periphery 6 and the hollow interior 8. Typically, the total number of molten plastic conduits disposed per meter height upon the outer periphery 6 of the rotor 3 is between approximately 1,000 and approximately 15,000. The preferred embodiment has a total of 8200 molten plastic conduits 10, which are disposed in a 200 by 41 regular array that stretches around cylindrical member 4.

In the preferred embodiment, each of the molten plastic conduits 10 extends radially and is substantially perpendicular to the central axis 5. However, in other embodiments some or all of the molten plastic conduits 10 extend obliquely.

In use, once the plastic has melted due to frictionally bearing against the rotating outer periphery 11, the molten plastic flows through the molten plastic conduits 10 and into the hollow interior 8 of the rotor 3. Whilst inside the hollow interior 8, the rotation of the rotor 3 promotes further mixing and homogenising of the molten plastic. The cross-sectional shape of the molten plastic conduits 10 may be any shape that allows for the desired molten plastic flow properties, for example circular, square or conical. In the preferred embodiment, each of the molten plastic conduits 10 has a circular cross-sectional shape. The diameter of the circular molten plastic conduits 10 is typically between approximately 4 mm and approximately 15 mm inclusive. In the preferred embodiment this diameter is approximately 8 mm. Hence, each of the molten plastic conduits 10 typically has a cross-sectional area of between approximately 12 mm² and approximately 180 mm² inclusive. In the preferred embodiment the cross-sectional area of each of the circular molten plastic conduits 10 is approximately 50 mm².

If each of the molten plastic conduits 10 were to have an excessively small cross-sectional area, then this would likely lead to overheating of the molten plastic prior to it flowing through the molten plastic conduits 10. Another downside potentially associated with molten plastic conduits 10 having an excessively small cross-sectional area is that it would require the plastic to be forced to bear against the outer periphery 6 of the rotor 3 at undesirably high pressures.

If each of the molten plastic conduits 10 were to have an excessively large cross-sectional area, then this would likely allow cooler, more viscous molten plastic to flow through the conduits 10, which would inhibit mixing and homogenising of the molten plastic.

Another factor that impacts upon the flow properties yielded by the molten plastic conduits 11 is the proportion of total conduit surface area (i.e., as calculated by performing an addition of the surface areas of each of the conduits 10) to the total surface area of the outer periphery 6 of the rotor 3 against which the plastic bears. Typically, this proportion is between approximately 1% and approximately 30%. A proportion of less than 1% is likely to cause the plastic to become too hot prior to passing through the conduits 10, which is inefficient. Additionally, such a low proportion is likely to excessively lower the overall plastic processing rate of the apparatus 1. A proportion of greater than 30% is likely to allow the plastic to pass through the conduits 10 at excessively low temperatures, which would inhibit mixing and homogenisation of the molten plastic. In the preferred embodiment this proportion is approximately 10%.

Depending upon the properties of the material from which the rotor 3 is made, the thickness between the outer periphery 6 and the inner face 7 is typically between approximately 3 mm and approximately 20 mm inclusive and in the preferred embodiment this thickness is approximately 12 mm. If this thickness is less than approximately 3 mm, then the outer periphery 6 is unlikely to be strong enough to withstand the pressure at which the plastic bears against it during operation of the apparatus 1. However, if this thickness is greater than approximately 20 mm, then the rotor 3 is likely to be excessively heavy, expensive to manufacture and may not offer suitable thermal conductivity properties.

The outer periphery 6 of the rotor 3 of the preferred embodiment has a diameter of 1060 mm. It has been appreciated by the inventors that the sizing of the rotor 3 must be carefully selected so as to balance various issues that may otherwise arise during operation of the apparatus 1. For example, for the frictional heater 2 to deliver sufficient heat to yield a commercially acceptable melting rate, the outer periphery 6 of the rotor 3 against which the plastic bears should move relative to the unmelted plastic at a velocity (which is hereinafter referred to a “face velocity”) of greater than 0.5 m/s. This consideration dictates a lower limit of approximately 0.2 m for the diameter of the outer periphery 6 of the rotor 3 because, at a typical operational rate of rotation, a smaller diameter would yield an inadequate face velocity. However, an excessively high a face velocity is also undesirable because the frictional heat would be generated too quickly and contaminants such as sand and dirt particles that would otherwise have been surrounded and transported by the viscous molten plastic may potentially bridge between the outer periphery 6 and the solid unmelted plastic that is being forced towards the rotor 3. This bridging has the potential to result in erosion and damage to the rotor 3. Ideally, the layer of molten plastic that surrounds the outer periphery 6 should be maintained with sufficient depth in order to minimise and potentially eliminate physical damage to the rotor 3. Hence, the face velocity should not exceed approximately 5.0 m/s. This consideration mitigates in favour of an upper limit of approximately 2.0 m to the diameter of the outer periphery 6 of the rotor 3 because, at a typical operational rate of rotation, a larger diameter would yield an excessively high face velocity. It would be possible to achieve a lower face velocity, despite an unusually large rotor diameter, by rotating the large rotor 3 at a very low rate of rotation. However, it has been appreciated by the inventors that this is undesirable because the slow rotation would fail to promote sufficient mixing and homogenising of the molten plastic. Hence, this is another consideration that mitigates in favour of an upper limit of approximately 2.0 m to the diameter of the outer periphery 6. The face velocity typically used during operation of the preferred embodiment is approximately 2.6 m/s.

The hollow interior 8 of the rotor 3 is in fluid communication with an outlet 11, with a hollow tapered section 12 being disposed intermediate the cylindrical member 4 and the outlet 11. In use, the molten plastic flows under gravity down the inner face 7, through the hollow tapered section 12 and out the outlet 11 so as to exit the rotor 3. In some embodiments, further plastics processing machinery, such as moulding or extrusion equipment, is disposed underneath the outlet 11 so as to receive and further process the molten plastic.

A ceramic heating element 13 is disposed adjacent to an external surface of the hollow tapered section 12 adjacent the outlet 11. This heating element 13 heats the lower end of the rotor 3 to approximately 200° C. to 220° C., which assists in promoting plastic flow during cold starting of the apparatus 1. Additionally, the heating element 13 is advantageous if the operation of the apparatus 1 is unexpectedly interrupted, for example due to a power failure. If such an interruption lasts long enough, the plastic is likely to solidify within the lower end of the rotor 3. This can potentially cause a blockage of some of the conduits 10 and a blockage of the outlet 11. Once power is restored, the heating element 13 is used to re-melt the plastic to allow operation of the apparatus 1 to re-commence.

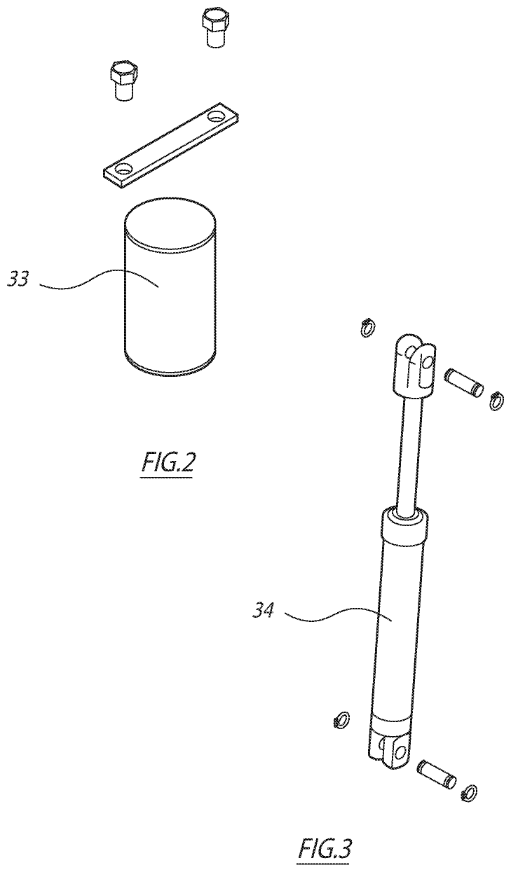

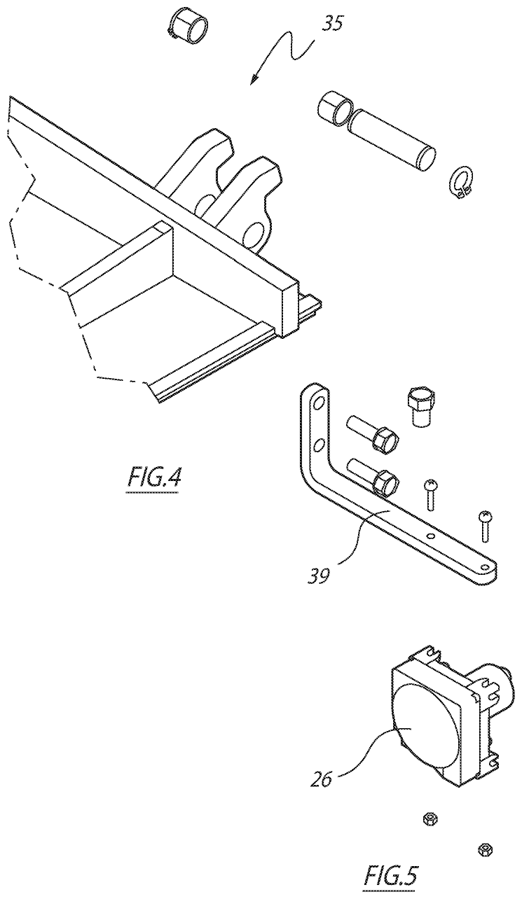

As best shown in FIG. 1, the apparatus 1 includes a pair of pushers 14 configured to push the plastic feedstock into frictional engagement with the outer periphery 6. Each of the pushers 14 includes a chamber 15 having a pair of loading doors 16 hingedly attached via hinge arrangements 35 (as best shown in FIG. 4) that can be rotated upwardly into open positions to allow a bale of plastic feedstock to be positioned within the chamber 15. Door cylinders 34 (as best shown in FIG. 3) are configured to automatically open and close the loading doors 16.

Each of the pushers 14 includes a shoe 17 that is sized to as to fit snuggly within the chamber 15. The side of the shoe 17 that faces the rotor 3 has a curvature that substantially matches the curvature of the outer periphery 6 of the rotor 3. The opposite side of the shoe 17 is connected via shoe retaining pin 33 (as best shown in FIGS. 2 and 10) to proximal ends of a pair of hydraulic rams 18. The hydraulic rams 18 extend between the shoe 17 and the wall 19 at the distal end of the chamber 15. The distal ends of the hydraulic rams 18 are firmly secured to the wall 19. Hence, when it is desired to displace the shoe 17 within the chamber 15, the hydraulic rams 18 may be either extended so as to displace the shoe 17 towards the rotor 3 or retracted so as to displace the shoe 17 away from the rotor 3.

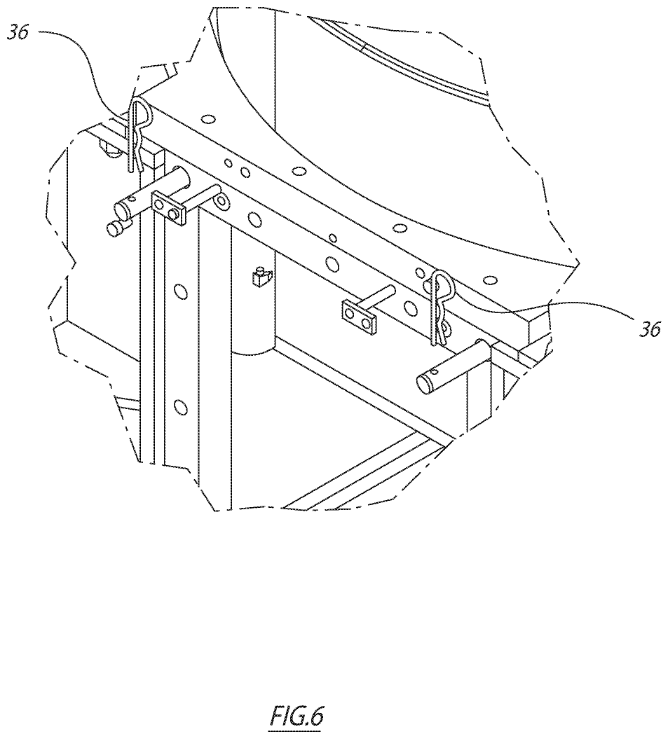

A pair of service access doors 27 are respectively disposed on either side of the chambers 15 adjacent to the rotor 3. The service access doors 27 may be secured to the chamber 15 with fasteners 36 (as best shown in FIG. 6). Removal of the service access doors 27 allows an operator to access the rotor 3 and its surrounds either for routine servicing, maintenance and repairs or to remove a contaminant object that cannot be processed in the ordinary course of operation of the apparatus 1.

A pair of wire encoders 26 (as best shown in FIG. 5) are respectively disposed at the distal ends of the two chambers 15 via brackets 39. These wire encoders 26 track the position of the rams 18, which correlates with the positions of the shoes 17. This information is sent to the controller, which enables the controller to monitor the position and/or speed of each of the shoes. This allows the controller to determine if the shoes are travelling too fast (which may have safety implications) or too slow (which may indicate that a contaminant is not melting and thereby obstructing the progress of the plastic towards the outer periphery 6).

In use, the four rams 18 are firstly fully retracted such that the two shoes 17 are each positioned at the respective distal ends of the two chambers 15 (i.e., the shoes are positioned adjacent to the walls 19). The loading doors 16 are then opened and a bale of plastic is positioned into each of the chambers 15. The loading doors 16 are then secured shut and the plastic in the chambers 15 is ready for processing.

The apparatus 1 includes a drive 20 operably coupled to the rotor 3. More specifically, the drive includes a motor 21, which in the preferred embodiment is a TECO 315 MC Motor that is commercially available from TECO AUSTRALIA & New Zealand. The motor 21 is coupled to a gear unit 22, which in turn is coupled to top bearing housing assembly 23. A drive shaft 24 is axially disposed on the upper end of the rotor 3 and this shaft extends through the top bearing housing assembly 23 and is keyed into the gear unit 22 via slot 38 and corresponding shaft key 25. In this manner, torque generated by motor 21 is transmitted through the gear unit 22 so as to rotate the rotor 3. A control unit, in the form of a variable frequency drive, configures the drive 20 so as, in use, to rotate the rotor 3 such that the outer periphery 6 has a face velocity of between approximately 0.5 m/s and approximately 5.0 m/s inclusive. Depending upon the diameter of the outer periphery 6 of the rotor 3, this typically correlates to a rotor rotation rate of between approximately 20 rpm and approximately 200 rpm inclusive. The rotor rotation rate typically used in the preferred embodiment is about 35 rpm to 50 rpm inclusive.

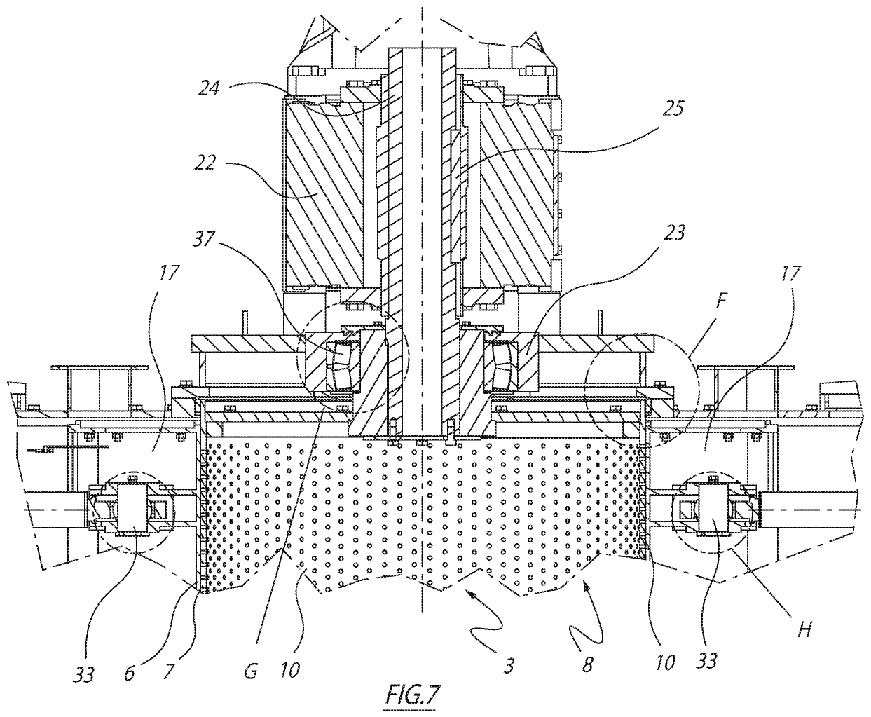

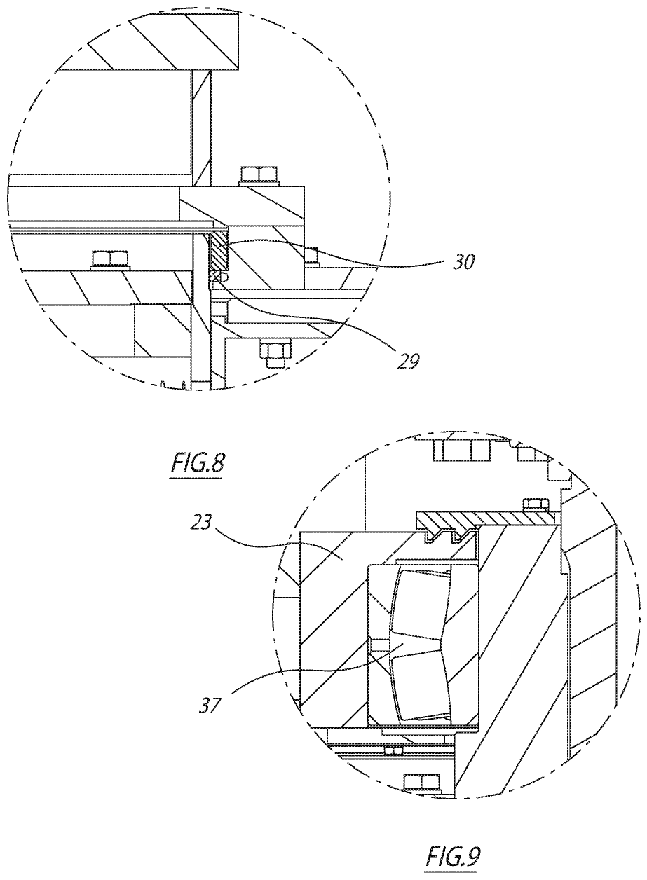

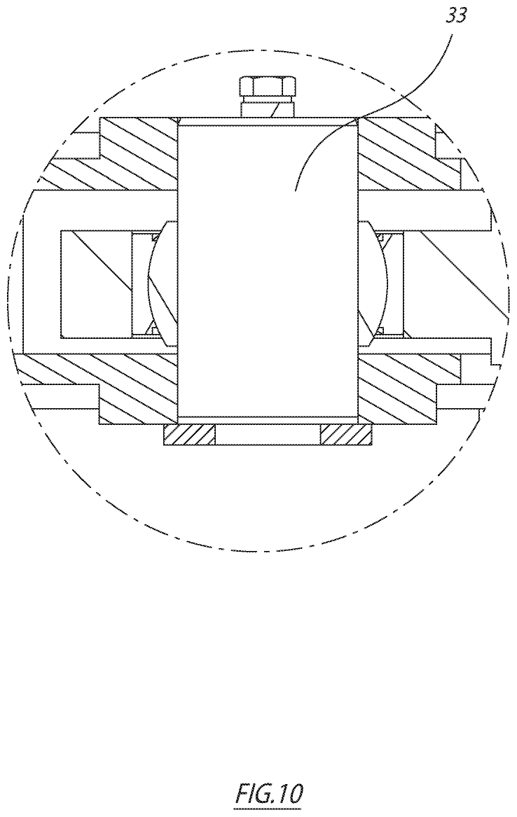

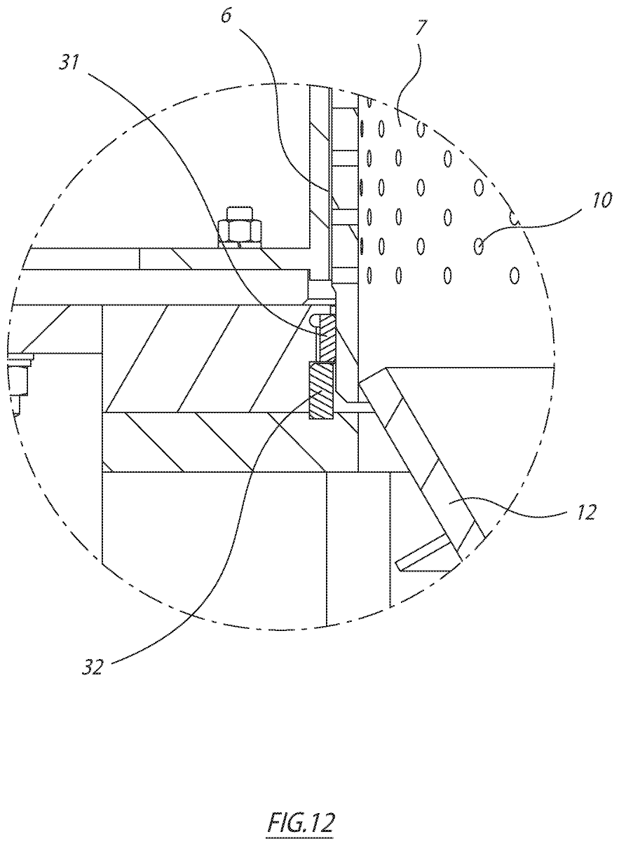

The rotor 3 is mounted within the apparatus 1 on bearings that allow for the rotor's rotation. The bearings 37 (as best shown in FIGS. 7, 9 and 11) are housed within top bearing housing assembly 23 and bottom bearing housing assembly 28. Additionally, an upper seal ring 29 and an upper wear ring 30 (as best shown in FIG. 8), along with a lower seal ring 31 and a lower wear ring 32 (as best shown in FIG. 12), are used to help seal and locate the rotor 3 within the apparatus 1. The upper and lower seal rings 29 and 31 are bronze and are greased with a heavy-duty grease suitable for high pressure and anti-wear applications, such as RENOLIT CXS GSM D grease, which is commercially available from Fuchs.

Once the rotor 3 is rotating at the desired operational rotation rate, the pusher is used to push the plastic feedstock into frictional engagement with the outer periphery 6 at a pressure of between approximately 100 KPa and approximately 1000 KPa inclusive (i.e., between approximately 14.5 psi and approximately 145 psi inclusive). A typical pressure utilised in the preferred embodiment is approximately 200 KPa to 400 KPa. This pressure is monitored indirectly by monitoring the pressure within the rams 18 of the pusher 14 via pressure sensors provided within the rams 18, which transmit the ram pressure to the controller. This ram pressure is proportional to the pressure at which the plastic feedstock is being pushed into frictional engagement with the outer periphery 6 of the rotor 3. In other words, the ram pressure may be correlated with the pressure pushing the plastic onto the rotor 3 via a consideration of ratio of the cross-sectional size of the rams 18 to the cross-sectional size of the shoe 17.

The friction and pressure at the outer periphery 6 causes the plastic to melt and then travel through the molten plastic conduits 10 and into the hollow interior 8 of the rotor 3. As this occurs, the rams 18 continue to exert pressure on the shoes 17, which in turn force each of the plastic bales to slowly progress further towards the outer periphery 6. Whilst the molten plastic is at the interface between the solid plastic and the outer periphery 6, and whilst the molten plastic is within the hollow interior 8, intimate mixing of the molten plastic occurs, which helps the apparatus 1 to yield an acceptably homogenous plastic output.

Once the wire encoder 26 reports to the controller that its respective shoe 17 is positioned sufficiently close to the outer periphery 6, the controller causes the rams 18 to retract the shoe 17 to enable re-loading of a new plastic bale into the chamber 15. Preferably the two chambers 15 are operated out of phase with each other to allow for the plastic feedstock in one chamber 15 to be processed, whilst a new bale of plastic feedstock is being loaded into the other chamber 15.

The melted plastic that exits from the outlet 11 of the plastics processing apparatus 1 may be subject to further processing, such as moulding, extrusion, and so forth, so as to form useful materials such as plastic beams and the like. In other embodiments, the plastic that exits from the outlet 11 of the plastics processing apparatus 1 may be coated onto other materials so as to form a composite material.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A rotor for use within a frictional heater, the rotor including:
a substantially cylindrical member disposed about a central axis, the substantially cylindrical member defining an outer periphery configured, in use, to bear against plastic, the substantially cylindrical member further defining a hollow interior;
a plurality of molten plastic conduits extending between said outer periphery and said hollow interior; and
the hollow interior being in fluid communication with an outlet;
wherein the outer periphery has a diameter of between approximately 0.2 m and approximately 2.0 m inclusive.

2. The rotor of claim 1, wherein the outer periphery has a diameter of between approximately 0.3 m and approximately 1.5 m inclusive.

3. The rotor of claim 1, wherein the cylindrical member defines an inner face substantially enclosing the hollow interior, the inner face being concentric with the outer periphery, and wherein a thickness between the outer periphery and the inner face is between approximately 3 mm and approximately 20 mm inclusive.

4. The rotor of claim 1, wherein each of the molten plastic conduits has a cross-sectional area of between approximately 12 mm² and approximately 180 mm² inclusive.

5. The rotor of claim 1, wherein each of the molten plastic conduits has a circular cross-sectional shape having a diameter of between approximately 4 mm and approximately 15 mm inclusive.

6. The rotor of claim 1, wherein a heating element is disposed adjacent the outlet.

7. The rotor of claim 6, wherein a hollow tapered section is disposed intermediate the cylindrical member and the outlet, and wherein the heating element is disposed on or adjacent to an external surface of the hollow tapered section.

8. The rotor of claim 1, wherein a total surface area of said molten plastic conduits comprises between approximately 1% and approximately 30% of a total surface area of said outer periphery that is configured, in use, to bear against plastic.

9. The rotor of claim 1, wherein between approximately 1,000 and approximately 15,000 molten plastic conduits per meter are disposed on said outer periphery that is configured, in use, to bear against plastic.

10. A plastics processing apparatus including:
a frictional heater having the rotor of claim 1, wherein the rotor is rotatably disposed therein such that an axis of rotation of the rotor is co-extensive with said central axis;
at least one pusher configured, in use, for the pushing of plastic into frictional engagement with said outer periphery; and
a drive operably coupled to the rotor.

11. The plastics processing apparatus of claim 10, wherein the drive is configured, in use, to rotate the rotor such that the outer periphery has a velocity of between approximately 0.5 m/s and approximately 5.0 m/s inclusive.

12. The plastics processing apparatus of claim 10, wherein the drive is configured so as, in use, to rotate the rotor such that the outer periphery has a velocity of between approximately 1.0 m/s and approximately 3.0 m/s inclusive.

13. The plastics processing apparatus of claim 10, wherein the drive is configured, in use, to rotate the rotor at a rate of between approximately 20 rpm and approximately 200 rpm inclusive.

14. The plastics processing apparatus of claim 10, wherein the pusher is configured, in use, to push plastic into frictional engagement with said outer periphery at a pressure of between approximately 100 KPa and approximately 1000 KPa inclusive.

15. A method for processing plastic including:
providing the plastics processing apparatus of claim 10;
using the pusher to push plastic feedstock into frictional engagement with the outer periphery of the rotor so as to substantially melt the plastic feedstock; and
allowing substantially molten plastic to flow through the plurality of molten plastic conduits to the hollow interior of the rotor so as to perform intimate mixing of the molten plastic.

16. The method of claim 15, wherein the rotor is rotated such that the outer periphery has a velocity of between approximately 0.5 m/s and approximately 5.0 m/s inclusive.

17. The method of claim 15, wherein the rotor is rotated such that the outer periphery has a velocity of between approximately 1.0 m/s and approximately 3.0 m/s inclusive.

18. The method of claim 15, wherein the rotor is rotated at a rate of between approximately 20 rpm and approximately 200 rpm inclusive.

19. The method of claim 15, further including pushing the plastic towards the outer periphery of the rotor such that the plastic frictionally engages with said outer periphery at a pressure of between approximately 100 KPa and approximately 1000 KPa inclusive.

20. Plastic processed by the plastics processing apparatus of claim 10.

21. (canceled)
